(19) United States
(12) Patent Application Publication
(10) Pub. No.: US 2008/0183440 A1
(43) Pub. Date: Jul. 31, 2008

(54) SYSTEM, APPARATUS AND METHOD FOR FACILITATING PATTERN-BASED CLOTHING DESIGN ACTIVITIES

(75) Inventor: Kathi R.E. Lind, Elgin, IL (US)

Correspondence Address: BELL, BOYD & LLOYD, LLP, P.O. Box 1135, CHICAGO, IL, 60690, US

(73) Assignee: DRAGON & PHOENIX SOFTWARE, INC., Elgin, IL (US)

(21) Appl. No.: 12/060,661

(22) Filed: Apr. 1, 2008

Related U.S. Application Data
(63) Continuation of application No. 11/345,068, filed on Jan. 31, 2006.

(51) Int. Cl. G06F 17/50; G06F 17/11; G06G 7/48

(52) U.S. Cl. 703/1; 703/2; 703/6

(57) ABSTRACT

A system usable by a processor to enable a user to select a type of garment and view an image of the pattern for the garment. Under direction of the system, the processor enables the user to input data relating to the characteristics of an intended wearer of the garment, and the processor generates a graphical model of the intended wearer. Also, under direction of the system, the processor enables the user to view a simulation of the garment worn on the graphical model. Furthermore, the system changes the pattern image in response to changes the user may make to the garment or the graphical model.

### PRIORITY CLAIM

This application is a continuation of and claims priority to and the benefit of U.S. patent application Ser. No. 11/345,068, filed Jan. 31, 2006, the entire disclosure of which is incorporated herein in its entirety.

### BACKGROUND

Apparel manufacturers, home sewers and other clothing makers typically make garments based on patterns. The pattern determines the size and shape of the garment. It is common for the clothing makers to refer to a pattern book to select their patterns. Each pattern in the book corresponds to a particular type of garment and a particular range of body measurements. Knowing the wearer's garment preference and body measurements, the clothing maker can select one of the patterns.

One disadvantage with this process is that it can exclude a significant degree of a person's uniqueness. For example, some people have hour glass-shaped torsos or rectangular-shaped torsos, while others have upwardly pointing triangular-shaped torsos or downwardly pointed triangular-shaped torsos. The range-based pattern selection process can exclude these unique factors from the garment design process.

To provide a better fit, garment makers sometimes manually alter the patterns. Other times, the wearers have their garments tailored to obtain a better fit. The process of altering patterns and obtaining tailoring services can be inconvenient, time consuming and relatively expensive. Consequently, many people skip these steps and choose to wear clothes with a fit that is inadequate or is only moderately complimentary to their unique shapes and sizes.

There is a need to overcome the disadvantages described above. There is also a need to provide improvements applicable to pattern-based design activities.

### SUMMARY

The pattern-based design system, in one embodiment, generally relates to a computerized system involving clothing or garment design and the production of customized patterns for the designed garment. The system can be used by clothing designers or manufacturers, including, without limitation, apparel design professionals, professional or hobby sewers, fashion designers and others involved in the clothing industry. The clothing design system can be used to design clothing for different types of wearers, including, without limitation, humans (adults and children), animals and pets, such as dogs and cats. For the case where the intended wearer is a human, the user of the system 10 can be the intended wearer.

In one embodiment, the clothing design system enables the user to: (a) select a desired garment; (b) view a pattern layout for the garment; (c) build a graphical model of the intended wearer based upon body characteristics input by the user; (d) view a simulation of the garment being worn on the graphical model; (e) make adjustments to the garment, the ease and fit of the garment or the size or shape of the graphical model; (f) automatically view an update of the pattern layout and measurement window based upon changes made in the garment or graphical model; and (g) print the pattern necessary to make the garment. This type of system provides users with enhanced convenience, efficiency and customization in designing garments and obtaining customized garment patterns.

The clothing design system has a plurality of technical effects or technical contributions. One such contribution is the reduction in data storage needs through use of vector-based graphical modeling in computerized clothing design. Another such contribution is the reduction in the amount of computer code or programming code which is necessary to generate models, where the models represent the bodies of intended wearers and the clothes they are wearing in a virtual environment. This reduction is programming code can be attributed to the use of multiple element layers in vector-based graphical modeling, as described further below.

Additional features and advantages are described herein, and will be apparent from, the following Detailed Description and the figures.

### BRIEF DESCRIPTION OF THE FIGURES

FIG. 1 is a diagrammatic view of one embodiment of the clothing design system, server, database, network, computer, printer, customized patterns and graphical user interface.

FIG. 2 is a schematic block diagram illustrating the modules of one embodiment of the clothing design system.

FIG. 3 a schematic block diagram illustrating the modules and functionality of the garment module of one embodiment of the clothing design system.

FIG. 4 a schematic block diagram illustrating the modules and functionality of the fabric module of one embodiment of the clothing design system.

FIG. 5 a schematic block diagram illustrating the modules and functionality of the layout module of one embodiment of the clothing design system.

FIG. 6 a schematic block diagram illustrating the modules and functionality of the wearer characteristic input module of one embodiment of the clothing design system.

FIG. 7 a schematic block diagram illustrating the modules and functionality of the modeling module of one embodiment of the clothing design system.

FIG. 8 is a side perspective view illustrating one example of the actual appearance of an intended wearer, the theoretical model applicable to such wearer, and the model generated for such wearer by one embodiment of the clothing design system.

FIG. 9 is a top plan view of a graphical user interface of one embodiment of the clothing design system, illustrating the pattern-shaped garment pieces being dynamically wrapped around the generated model.

FIG. 10 is a top plan view of a graphical user interface of one embodiment of the clothing design system, illustrating an example in which the pattern layout and measurement window is automatically updated when the user: (a) adds shoulder garment pieces to the garment worn on the generated model; and (b) changes certain measurements associated with the intended wearer.

FIG. 11 is a diagrammatic flow diagram illustrating the update operation of the coupling module of one embodiment of the clothing design system.

### DETAILED DESCRIPTION

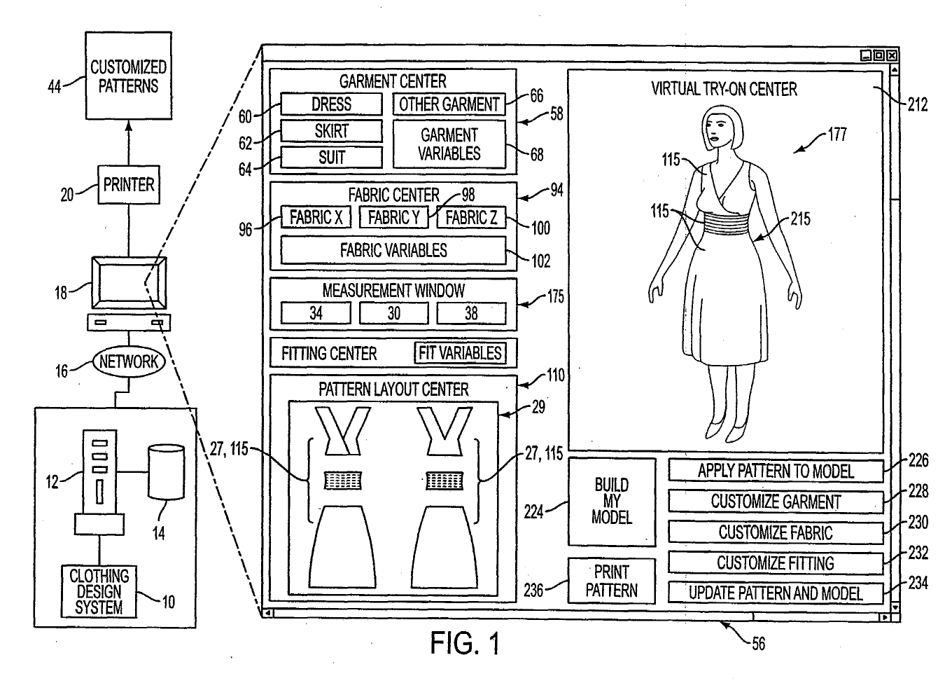

Referring now to the drawings, FIG. 1 illustrates one embodiment of the clothing design system 10. The clothing design system 10 includes a plurality of computer readable instructions which are accessible by one or more processors or servers 12. In one embodiment, the system 10 includes a plurality of programming modules which control the operation of the server 12. Each module includes a set of computer-readable instructions and data which are related to a designated function, purpose, subject matter or topic. This type of modular construction of the clothing design system 10 can be created using any suitable computer programming language or database, including, without limitation, JAVA, C++ or SQL for specifying business logic and other functions. In another embodiment, the clothing design system 10 is structured as a single module or single set of computer-readable instructions. In such case, this single set of computer-readable instructions has the functionality of the clothing design system's separate modules which are described in detail below.

The server 12 is coupled to one or more data storage devices or databases 14. The database 14 stores pre-stored data which is accessed or retrieved by the server 12, including, without limitation, one or more catalogs of garment data, one or more catalogs of fabric data, theoretical model data (described below) and default fitting data. Also, the database 14 stores the data input by the user for processing and future retrieval by the user.

In addition to being coupled to the database 14, the server 12 is coupled to an electronic network or a data network 16, such as a local area network, wide area network, public network or any portion of the Internet. This enables the user to access the system 10 anywhere the network 16 is accessible. In the example illustrated, one or more network access devices 18, such as a personal computer, is coupled to the network 16. It should be appreciated that the network access device 18 can include a standard desktop computer, a standard laptop computer, a personal digital assistant, a mobile phone with data processing capabilities or any other suitable network-enabled, computerized apparatus. The network access device 18 is coupled to one or more printers 20 which are operable to print text and images on paper.

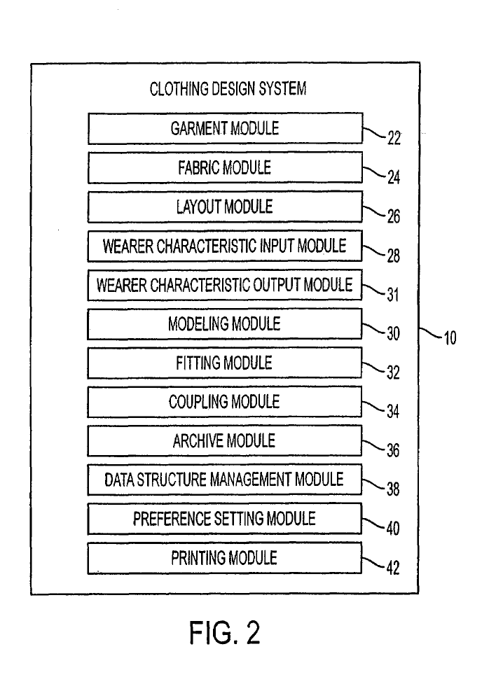

Referring to FIGS. 1 through 7, the clothing design system 10, in one embodiment, includes: (a) a garment module 22 which enables the user to select desired garment factors or parameters; (b) a fabric module 24 which enables the user to select desired fabric factors or parameters; (c) a layout module 26 which is used by server 12 to cause the computer 18 to display a two-dimensional pattern image 27 of the selected garment's pattern, and the pattern image 27 is displayed so as to overlay a two-dimensional fabric image 29 of the selected fabric; (d) a wearer characteristic input module 28 which enables the user to input a plurality of characteristics of the intended wearer of the selected garment; (e) a wearer characteristic output module 31 which causes the computer 18 to indicate to the user, the characteristic data input by the user; (f) a modeling module 30 which causes the server 12 to produce a three-dimensional graphical representation or model of the intended wearer who is trying-on the selected garment in a virtual environment; (g) a fitting module 32 which enables the user to adjust a plurality of fitting parameters or ease and fit settings while the selected garment is shown on the graphical model of the intended wearer; (h) a coupling module 34 which operatively couples the layout module 26 to the modeling module 30 and the wearer characteristic output module 31, as described in detail below; (i) an archive module 36 which enables the user to save and store desired files, images, settings and other data, as described further below; (j) a data structure management module 38 which enables the server 12 to manage the data which is input by the user as well as the data which is pre-stored in the database 14; (k) a preference setting module 40 which enables the user to set a plurality of settings or configurable parameters used to control the function and visual output of the clothing design system 10, as described further below; and (l) a printing module 42 which enables the server 12 to cause the printer 20 to print customized patterns 44, as described further below.

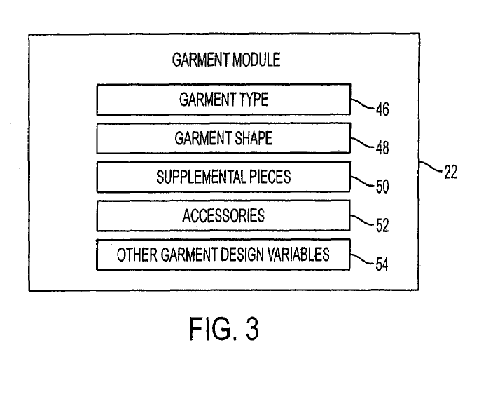

As best illustrated in FIG. 3, the garment module 22 enables the user to select the desired garment based upon a plurality of factors, including: (a) the garment type 46; (b) the garment shape 48; (c) supplemental pieces 50 which can be optionally added to the selected garment; (d) accessories 52 which can be optionally added to, or used in conjunction with, the selected garment; and (e) other suitable garment design variables 54.

In the example illustrated in FIG. 1, the clothing design system 10 causes the computer 18 to display a main graphical interface or main window 56. In this example, the garment center 58, controlled by the garment module 22, enables the user to input a selection from a category of dress 60, skirt 62, suit 64 or another type of garment 66. The garment center 58 also enables the user to select a plurality of other garment variables 68.

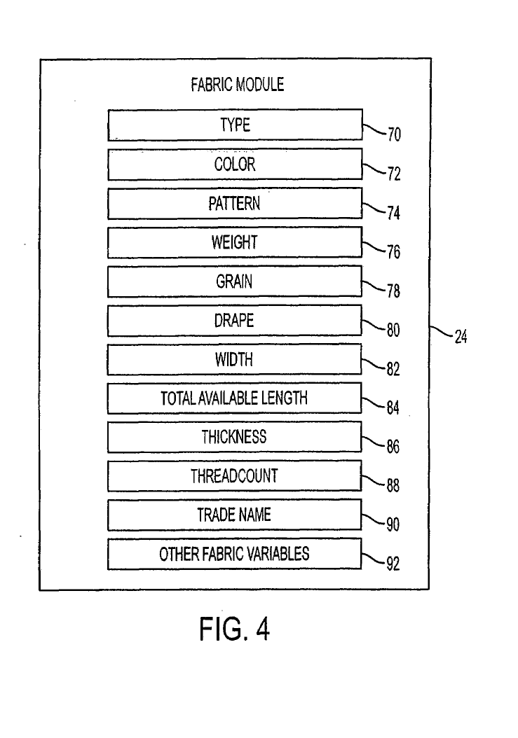

Referring to FIG. 4, the fabric module 24, in one embodiment, enables the user to select the desired fabric by type 70, color 72, pattern 74, weight 76, grain 78, grade 80, width 82, total available length 84, thickness 86, thread count 88, trade name 90 and other suitable fabric variables 92. Referring back to FIG. 1, in one example, the fabric module 24 causes the server 12 to display a fabric center 94. In this example, the fabric center 94 enables the user to select fabric X 96, fabric Y 98 or fabric Z 100. The fabric center 94 also enables the user to select a plurality of additional suitable fabric variables 102.

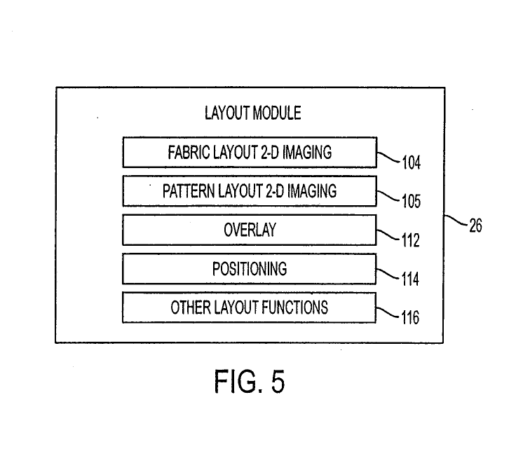

Referring to FIG. 5, the layout module 26, in one embodiment, includes: (a) a fabric layout 2-D imaging module 104 which enables the computer 18 to display the two-dimensional fabric image 29 as if the selected fabric were laid out on a table; (b) a pattern layout 2-D imaging module 108 which enables the computer 18 to display the two-dimensional pattern image 27 within the pattern layout center 110; (c) an overlay module 112 which is used by the server 12 to cause the computer 18 to visually lay the pattern image 27 on top of the fabric image 29; (d) a positioning module 114 which enables the server 12 to cause the pattern image 27 to be positioned or repositioned relative to the fabric image 29 based upon an automatic positioning process or based upon inputs made by the user; and (e) a plurality of other suitable layout functions 116 which cause the computer 18 to provide suitable visual outputs within the layout center 110 based upon an automatic process or inputs made by the user.

In one alternative embodiment, the fabric layout module 104 can, in one embodiment, display the fabric image 29 in a three-dimensional form. For example, an edge of the fabric can be illustrated with an edge image to illustrate the thickness of the fabric. It should be understood that the pattern layout module 104 can graphically represent the pattern corresponding to the selected garment by displaying a black or colored line, in solid or dotted form, which outlines the shape of such pattern. Alternatively, the pattern layout module 104 can display the pattern as a solid or filled-in image, in two-dimensional or three-dimensional form. In the example illustrated in FIG. 1, the selected garment is a ruched-waist dress which includes an assembly of six garment pieces displayed as six garment piece images 115. Accordingly, the pattern ; image 27 specifies the shape of this garment with a solid line outlining the six garment pieces.

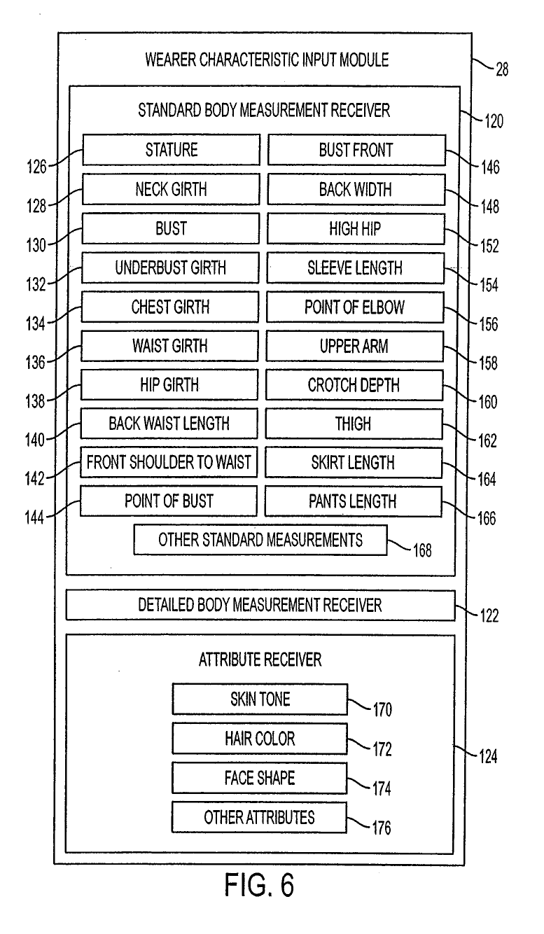

Referring now to FIG. 6, the wearer characteristic input module 28, in one embodiment, includes: (a) a standard body measurement receiver 120 which enables the user to input a plurality of body measurements relating to the intended wearer; (b) a detailed body measurement receiver 122 which enables the user to input a plurality of body measurements, beyond what might be considered to be industry standard measurements; and (c) an attribute receiver 124 which enables the user to input a plurality of attributes of the intended wearer, where the attributes are not necessarily measurable by dimensions. The wearer characteristic input module 28 enables the user to enter or input the data through use of a keyboard, touch screen, microphone or other suitable input device.

The measurements receivable by the standard body measurement receiver 120 can be determined by any suitable industry standard, including, without limitation, the standards set by ASTM International, a standards development organization originally known as the American Society for Testing and Materials. In the example illustrated in FIG. 6, the standard body measurement receiver 120 enables the user to input the following measurements of the intended wearer: stature 126, neck girth 128, bust 130, under bust girth 132, chest girth 134, waist girth 136, hip girth 138, back waist length 140, front shoulder to waist 142, point of bust 144, bust front 146, back width 148, high hip 150, sleeve length 152, point of elbow 156, upper arm 158, crotch depth 160, thigh 162, skirt length 164, pants length 166 and other suitable standard measurements 168.

The detailed body measurement receiver 122 enables the user to input measurements of the intended wearer which specify or describe the wearer's size or shape at points of the body which lie between the measurement points of the standard body measurement receiver 120. For example, the detailed body measurement receiver 122 may enable the user to input the user's torso circumference at a height of seven inches above the crotch, at another height of seven and one-half inches above the crotch, at another height of eight inches above the crotch, at another height of eight and one-half inches above the crotch, and at another height of nine inches above the crotch. The detailed body measurement receiver 122 can enable the user to input these types of measurements for the user's entire torso, legs, arms, neck and entire body. As described further below, the system 10 uses this detailed input data to generate a relatively detailed map or model of the topology of the intended wearer's body.

With continued reference to FIG. 6, the attribute receiver 124 enables the user to input the attributes of the intended wearer which may or may not be measurable in terms of dimensions or magnitude. For example, the attribute receiver 124 can enable the user to input data corresponding to the intended wearer's skin tone 170, hair color 172, general face shape 174 and other suitable attributes 176.

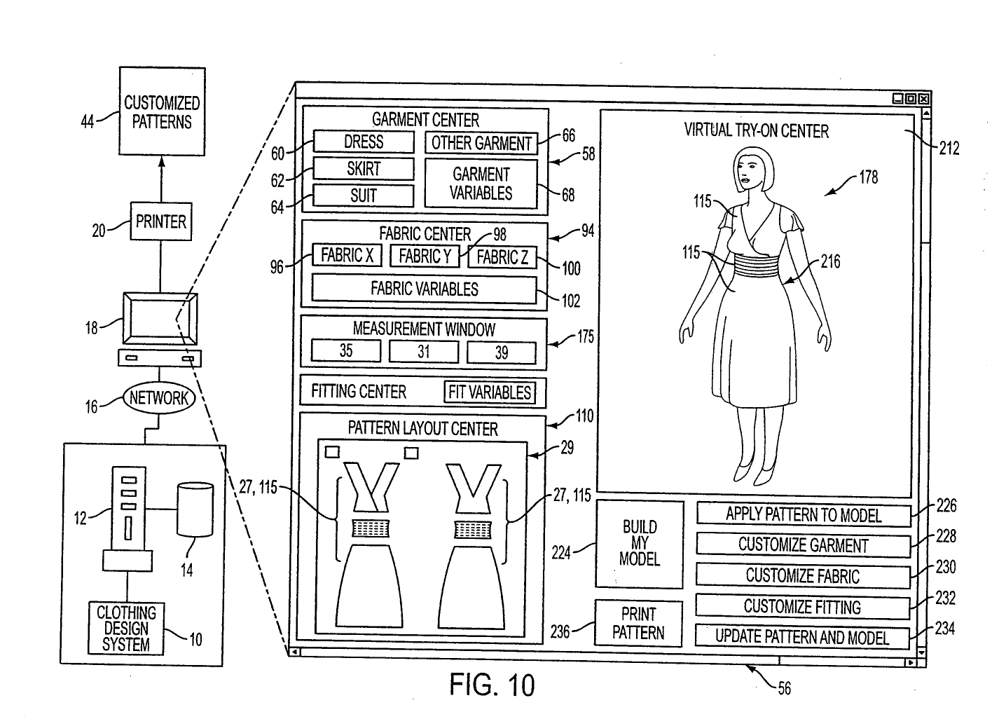

After the server 12 receives the wearer's data input through the wearer characteristic input module 28, the wearer characteristic output module 29 enables this data to be viewed by the user. The wearer characteristic output module 29, in one embodiment, causes the computer 18 to display a measurement window, image or characteristic window 175, as illustrated in FIGS. 1 and 10. The characteristic window 175 displays or graphically indicates the measurements and other characteristic data which is input by the user. In one embodiment, the characteristic window 175 displays the inches or centimeters of the girths, widths, lengths and other measurements received by the wearer characteristic input module 28.

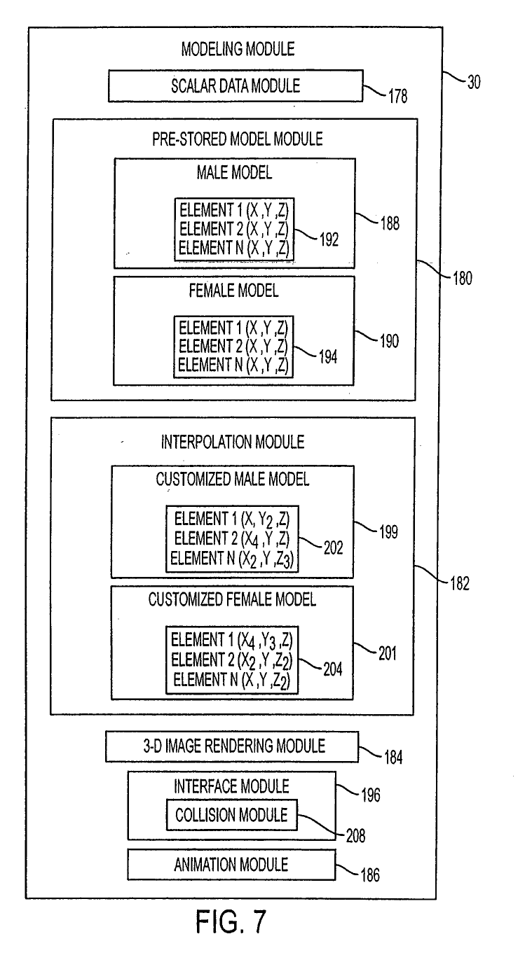

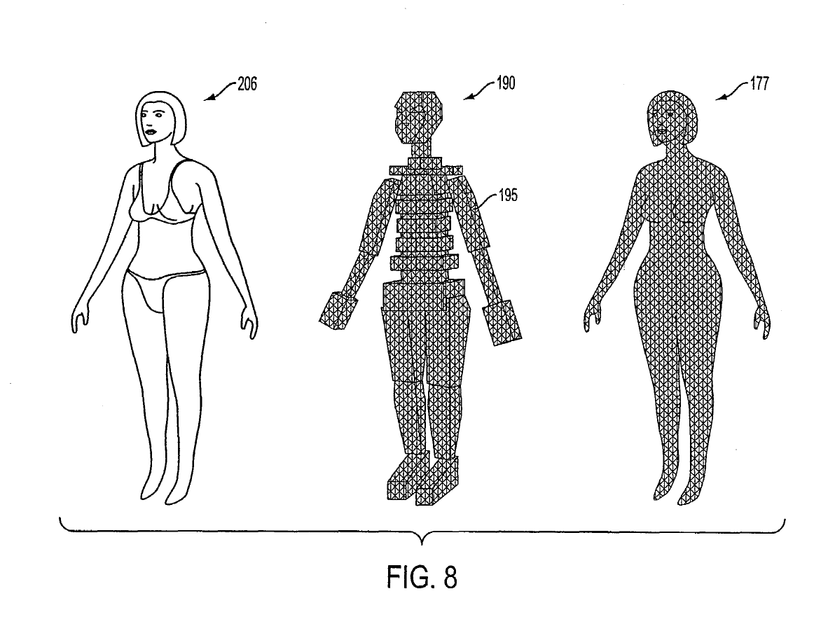

Referring to FIGS. 7 and 8, the modeling module 30, in one embodiment, includes a vector graphics system or a vector modeling system which enables the server 12 to generate a three-dimensional model of the intended wearer. This model of the wearer will, at times, be referred to herein as the generated model 177. In this type of system, a vector data is used to represent discrete features that are defined as points, lines and polygons. In one embodiment, the vector data represents these features as pairs or sets of X, Y, and Z coordinates, and each coordinate set specifies an element, as described below. Each element can be described by a mathematical matrix. Accordingly, the surface of a person's body can be described by a layer of matrices, and a garment can be described by another layer of matrices. As such, the vector-based modeling module 30 can enable the server 12 to generate a model of a person wearing a garment through the use of multi-layered matrices.

In one embodiment, this vector-based modeling module 30 includes: (a) a scalar data module 178 which enables the server 12 to manage and process the scalar data received by the user through use of the wearer characteristic input module 28; (b) a theoretical or pre-stored model module 180 which enables the server 12 to access a plurality of data sets stored in the database 14 which are associated with different, predetermined, generic or theoretical body models; (c) an interpolation module 182 which enables the server 12 to interpolate a plurality of data points, data coordinates or data values based upon the data associated with the pre-stored models and the data input by the user through use of the wearer characteristic input module 28; (d) a three-dimensional image rendering module 184 which enables the server 12 to convert or transform the vector data into bitmap or pixel data which is displayable by the display device of the computer 18; and (e) an animation module 186 which enables the server 12 to animate the generated model 177.

In the example illustrated in FIG. 7, the pre-stored model module 180 enables the server 12 to access and process a data set associated with a theoretical male model 188, and the pre-stored model module 180 enables the server 12 to access and process a data set associated with a theoretical female model 190. These data sets are stored within the database 14.

The theoretical models 188 and 190 include a plurality of elements 192 and 194, respectively. Each such element is associated with a plurality of coordinate points or coordinate values, such as an X coordinate value, a Y coordinate value and a Z coordinate value. These elements 195 define a meshwork which is the basis for the body surface of the theoretical models 188 and 190. The generic or theoretical data used to create these models 188 and 190 can be derived from a plurality of sources, including, without limitation: (a) ASTM International; and (b) survey or response data collected or derived through questions, forms or surveys presented to one or more populations, people, organizations or other entities. It should be appreciated that the pre-stored model module 180 can include data sets associated with an array of theoretical models, such as a model associated with individuals of different ages or different ranges of height, body weight, size or skeletal structure.

In the example illustrated in FIG. 8, each element 195 has a designated triangular shape. It should be appreciated, however, that any suitable shape can be used, including, without limitation, triangular, square, rectangular or any suitable polygon or geometry.

Referring back to FIG. 7., the interpolation module 182 includes a plurality of interpolation algorithms usable by the server 12 to interpolate data points or data values based on the measurement data input by the user and the data sets associated with the theoretical models. As a result, the interpolation module 182 enables the server 12 to produce a customized male model 198 which would represent the generated model if the wearer were a male, and the interpolation module 182 enables the server 12 to produce a customized female model 200 which would represent the generated model if the wearer were a female, such as the generated model 177 illustrated in FIGS. 1 and 8.

As illustrated in FIG. 7, the interpolation module 182 makes certain changes or modifications to the elements of the theoretical models. These modifications are based on a set of designated interpolation algorithms. The interpolation algorithms enable the server 12 to transform elements 192 and elements 202 to correspond to the unique body characteristics input by the user. As illustrated in FIG. 7, the Y₂, X₄, X₂, and Z₃ values of the transformed elements 202 indicate that the server 12 has modified, estimated or interpolated certain coordinate values to generate the customized male model 199. Likewise, the X₄, Y₃, X₂ and two Z₂ values of the transformed elements 204 indicate that the server 12 has modified, estimated or interpolated certain coordinate values to generate the customized female model 201.

In operation of one example, the intended wearer is a female with the actual appearance 206 illustrated in FIG. 8. It should be understood that the actual appearance 206 is shown in FIG. 8 only for purposes of describing the modeling function of system 10. The clothing design system 10 can perform all of the functions described herein without requiring any photos or scanning of the intended wearer.

Continuing with this example, the system 10 retrieves the data set associated with the theoretical female model 190 for modeling purposes. Using the wearer characteristic data input by the user, the interpolation module 182 causes the server 12 to perform an interpolation process which results in the generated model 177 illustrated in FIGS. 1 and 8.

In one embodiment, the database 14 stores a plurality of vector data sets associated with a plurality of different types, styles and sizes of garments. Accordingly, both the selected garment and the generated model 177 are vector-based. As such, the interface module 196 enables the computer 18 to display the garment piece images 27 on the generated model 177. In particular, the interface module 196 enables the server 12 to mathematically and graphically interface the garment piece images 27 with the generated model 177.

The interface module 196, in one embodiment, includes a collision module 208. The collision module 208 enables the server 12 to mathematically and graphically attach the garment piece images 27 to designated attachment points of the generated model 177. In addition, the collision module 208 is coupled to the fitting module 32, described below. Based on the user's ease and fit inputs, the collision module 208 enables the server 12 to adjust the spatial relationship between the garment piece images 27 and the generated model 177.

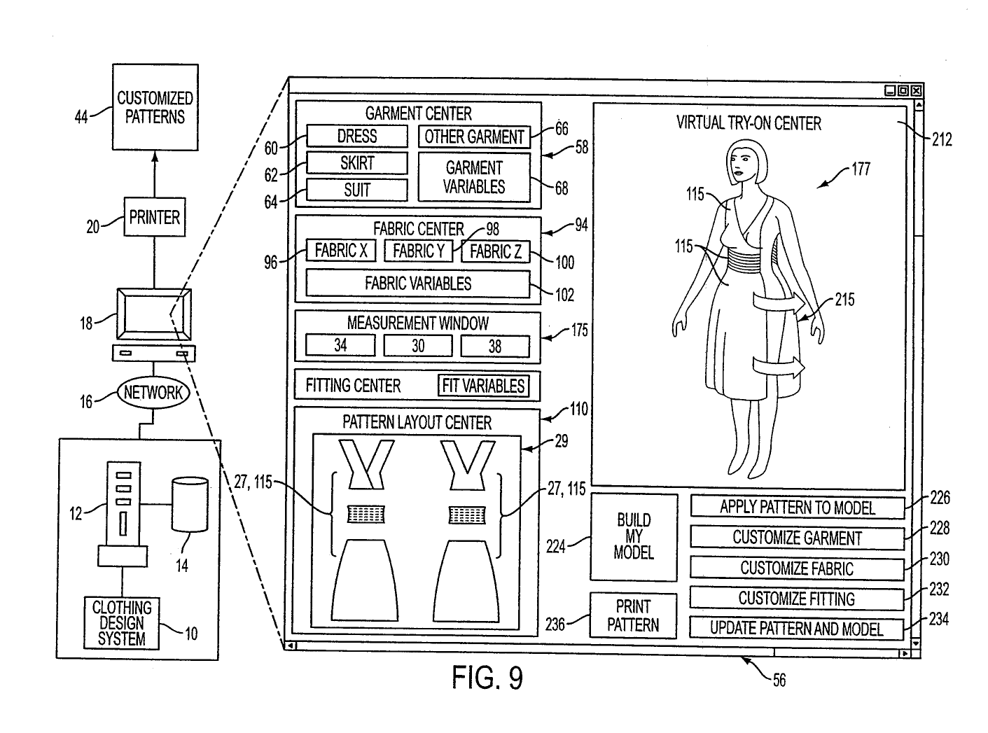

Referring back to FIG. 7, the animation module 186 is used by the server 12 to generate a video or any other suitable animation of the generated model 177. In one embodiment, the animation module 186 enables the server 12 to simulate the wrapping of the garment piece images 27 around the generated model 177. In another embodiment, the animation module 186 enables the server 12 to cause the generated model 177 to change stances, move his or her arms or have other body motion while the garment piece images 27 are being worn on the generated model 177. In the example illustrated in FIG. 9, the server 12, under control of the animation module 186, is simulating the garment piece images 27 being wrapped around the generated model 177. In one embodiment, the modeling module 30 enables the user to rotate the generated model 177 through three hundred sixty degrees so the user can view the front, sides and back of the model, and the modeling module 30 also enables the user to view the generated model 177 from a plurality of different viewing angles.

Referring to FIGS. 1, 10 and 11, the linkage or coupling module 34 links the changes made in the virtual try-on center 212 to the changes made in the pattern layout center 110 and the characteristic window 175. In the example illustrated, the user initially selected the sleeveless dress 214 illustrated in FIG. 1, and the user initially input measurements of thirty-four inches, thirty inches and thirty-eight inches corresponding to bust, waist and hip measurements, respectively. Next, the user customized the sleeveless dress 214 by adding shoulder pieces 215, and the user also updated the bust, waist and hip measurements to thirty-five inches, thirty-one inches and thirty-nine inches, respectively. This resulted in the sleeved dress 216 illustrated in FIG. 10, and this also resulted in the updated measurements shown in the characteristic window 175. After the user made the measurement changes and added the shoulder pieces 215 to the generated model 177, the coupling module 34 caused the shoulder pieces 215 to automatically appear in the pattern layout center 110. At the same time, the coupling module 34 updated the measurements in the characteristic window 175. In addition, the coupling module 34, in conjunction with the layout module 24, caused the server 12 to automatically update the pattern dimensions based on the measurement changes and shoulder piece additions. It should be appreciated that the same type of process can operate in reverse order. For example, if the user adds shoulder pieces 215 to the pattern layout center 110, the coupling module 34 can cause the server 12 to automatically update the generated model 177 with the newly added shoulder pieces 215.

It should also be appreciated that the coupling module 34 can cause the pattern layout center 110 and characteristic window 175 to automatically reflect any suitable change made in the virtual try-on center 212. Likewise, the coupling module 34 can cause the virtual try-on center 212 to automatically reflect any suitable change made in the pattern layout center 110. In one embodiment, for example, if the user changes a body characteristic, such as the dimension of the waist girth 136, the clothing design system 10 can automatically update the characteristic window 175 and the generated model 177, including the size and shape of the garment pieces 115 worn on the generated model 177. In addition, the clothing design system 10 can automatically update the pattern layout center 110 to indicate the change in the dimension of the pattern pieces to reflect the changes in the waist girth measurement.

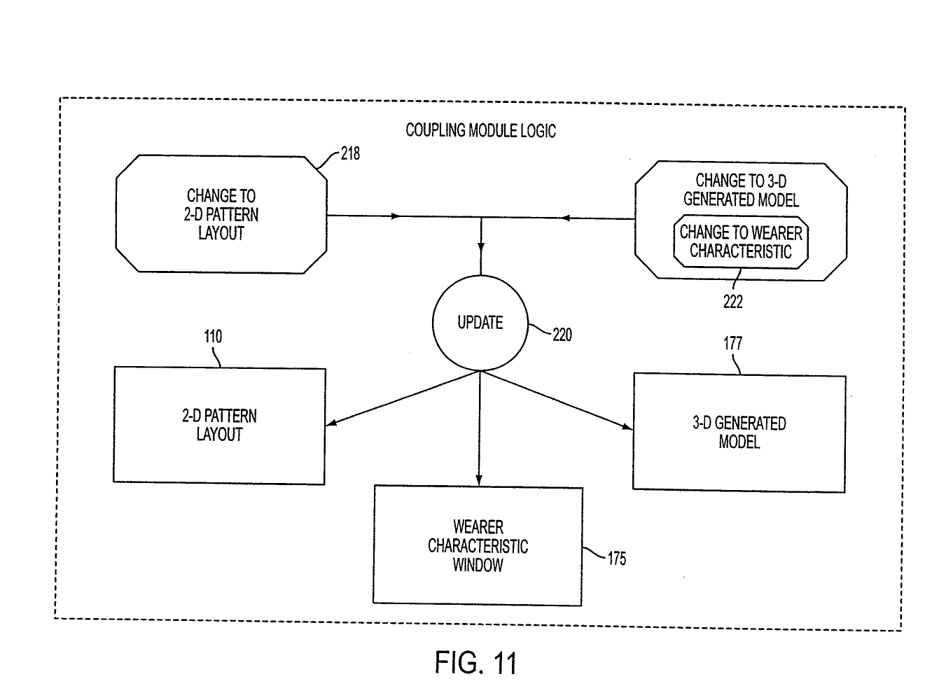

As illustrated in FIG. 11, the linkage or coupling module 34 facilitates the iterative clothing design process by enabling the user to visualize interactive changes in a virtual try-on environment, while automatically transmitting those changes to the pattern layout and the characteristic window. In operation of one example, the user makes a change to the two-dimensional pattern layout 110, as indicated by step 218. As indicated by update step 220, the server 12 uses the coupling module 34 to automatically and simultaneously update the two-dimensional pattern layout 110, the three-dimensional generated model 177 and the garment worn on the generated model. After that, the user changes the hip measurement for the three-dimensional generated model 177, as indicated by step 222. As indicated by update step 220, the server 12 uses the coupling module 34 to automatically and simultaneously update the two-dimensional pattern layout 110, the three-dimensional generated model 177, the garment worn on the generated model and the wearer characteristic window 175.

Depending upon the type of change made, the coupling module 34 can trigger an automatic dual update of the pattern layout 110 and generated model 177, or the coupling module 43 can trigger an automatic tri-update of the characteristic window 175, pattern layout 110 and generated model 177. In one embodiment, the coupling module 34 includes a plurality of designated coupling algorithms which enable the server 12 to perform the update step 220.

As described above, the fitting module 32 of the clothing design system 10 generally enables the user to adjust a plurality of ease and fit settings while the selected garment is shown worn on the generated model 177. These ease and fit settings, which are pre-stored in the database 14, can include, without limitation, a drape variable, a looseness variable, a tightness variable and any other suitable fit variable.

As described above, the archive module 37 of the clothing design system 10 enables the user to store information in the database 14 for later use. This information can include patterns that the user has set-up, garment types designed by the user, fabric settings that the user has established, a plurality of generated models built by the user, online account information and other suitable files and information.

The preference setting module 40 of the clothing design system 10 enables the user to set and control a plurality of operating parameters for the system 10. In one embodiment, the preference setting module 40 enables the user to set the user's preferences relating to the clothing design or garment design process. Such preferences can include, without limitation, personal profile settings for the generated model, such as hair color, sex or skin tone. In addition, the preference setting module 40 enables the user to set a plurality of system preferences including, without limitation, font type, display settings, sound settings, color scheme settings and other configurable parameters.

The printing module 42 of the clothing design system 10 enables the server 12 to cause the printer 20 to print customized patterns 34 using a standard printer driver or any other suitable printer driver. In one embodiment, the printer module 42 includes a print preview module which enables the user to preview the patterns 44 as laid out on printing paper before actually printing the patterns 44. The printing module 42 also enables the user to select the paper size and type from a plurality of paper settings, including, without limitation, eight and one-half inch by eleven inch sized paper or A4 sized paper sized paper, each of which is suitable for personal computer printers. The paper settings can also enable the user to print patterns 44 on larger paper suitable for commercial-based or industrial-based pattern printing systems. In either case, the print preview function of the printing module 42 enables the user to position the patterns on one or more sheet images so as to minimize or reduce the amount of paper necessary to print a customized pattern 44. In addition, the printing module 42 includes a plotting tool which facilitates the plotting of the pattern images on the paper.

Referring back to FIG. 1, the clothing design system 10, in one embodiment, provides the user with access to a database and a graphical user interface which enables the user to: (a) select the desired garment to be made; (b) select the desired fabric for the garment; (c) lay the pattern over the fabric on a virtual table 110; (d) activate the build-my-model input 224 to build a three-dimensional generated model 177 of the intended wearer based upon body characteristics entered by the user using a keyboard, touch screen or other suitable input device; (e) apply the pattern to the generated model 177 by activating the apply input 226, resulting in a simulation of the patterned garment being wrapped around the generated model 177; (f) activate the customize garment input 228 to make adjustments to the garment or body size or shape of the generated model 177; (g) activate the customize fabric input 230 to make adjustments to the fabric type of fabric; (h) activate the customize fitting input 232 to make adjustments to ease and fit variables of the garment worn on the generated model 177; (i) activate the update input 234 to view an update of the pattern layout and measurement window which the server 12 automatically generates based upon changes made in the virtual try-on center 212; and (j) activate the print pattern input 236 to print the customized patterns 44 necessary to make the garment as viewed on the three-dimensional generated model 177. This type of system provides users with enhanced convenience, efficiency and customization in designing garments and generating garment patterns.

In one alternative embodiment, the structure and functionality of system 10 is applicable to the design of upholstery for furniture (such as slip covers), window treatments (such as drapes), accessories (such as pillows), home decoration items and other fabric devices or fabric items which are designable through the use of templates or patterns. The term fabric item, as used below, will be a general reference to any one of these types of pattern-based fabric devices or items. In this embodiment, the pattern-based design system includes the structure, components and functionality of the clothing design system 10 described above, except that: (a) the garment is replaced with the particular fabric item being designed (such as a slip cover for a sofa); (b) the garment module 22 is replaced with a fabric item module (such as a slip cover module); (c) the generated model 177 is a generated model of the structure (such as a sofa) which will support a corresponding fabric item; (d) the wearer characteristic input module 28 is operable to receive characteristics (such as, sofa height, width and depth) associated with the structure that will carry the fabric item; and (e) the modeling module 30 is operable to enable the server 12 to generate a three dimensional graphical model of such structure based upon: (i) pre-stored data p associated with such type of structure; and (ii) the measurement and characteristic inputs provided by the user.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A data storage device comprising:
a plurality of computer-readable instructions executable to:
(a) graphically represent at least one pattern piece;
(b) receive at least one user-provided data point corresponding to at least one body characteristic of a possible wearer;
(c) access at least one model data point of at least one model;
(d) apply at least one mathematical formula to the user-provided data point and the model data point, the application of the mathematical formula resulting in at least one output data point;
(e) change the model by adding:
(i) the user-provided data point to the model; and
(ii) the output data point to the model;
(f) graphically represent the changed model; and
(g) graphically represent at least one garment piece worn on the changed model, the at least one garment piece corresponding to the at least one pattern piece.

2. The data storage device of claim 1, wherein the mathematical formula includes an interpolation algorithm.

3. The data storage device of claim 2, wherein the output data point includes an interpolated data point.

4. The data storage device of claim 3, which includes at least one computer-readable instruction executable to: (a) access a data source which has data relating to a plurality of different shapes of humans; and (b) use the data source in the application of the mathematical formula.

5. The data storage device of claim 1, wherein the user-provided data point and the output data point data point correspond to a plurality of coordinate values.

6. The data storage device of claim 5, wherein the coordinate values define a mesh usable to represent a body surface of the changed model.

7. A method comprising:
(a) graphically representing at least one pattern piece;
(b) receiving at least one user-provided data point corresponding to at least one body characteristic of a possible wearer;
(c) accessing at least one model data point of at least one model;
(d) applying at least one mathematical formula to the user-provided data point and the model data point, wherein the application of the mathematical formula results in at least one output data point;
(e) changing the model by adding:
(i) the user-provided data point to the model; and
(ii) the output data point to the model;
(f) graphically representing the changed model; and
(g) graphically representing at least one garment piece worn on the changed model, wherein the at least one garment piece corresponds to the at least one pattern piece.

8. The method of claim 7, wherein applying the mathematical formula includes performing an interpolation.

9. The method of claim 8, wherein performing the interpolation includes using at least one interpolation algorithm.

10. The method of claim 9, which includes: (a) accessing a data source which has data relating to a plurality of different shapes of humans; and (b) using the data source in the performance of the interpolation.

11. The method of claim 7, which includes correlating the user-provided data point and the output data point data point with a plurality of coordinate values.

12. The method of claim 11, which includes using the coordinate values to define a mesh, wherein the mesh is usable to represent a body surface of the changed model.

13. A data storage device comprising:
a plurality of computer-readable instructions executable to:
(a) graphically represent at least a first pattern piece and a second pattern piece;
(b) graphically represent: (i) at least a first garment piece corresponding to the first pattern piece, and (ii) at least a second garment piece corresponding to the second pattern piece, the first and second garment pieces each having a plurality of sides including a first side and a second side;
(c) graphically represent a three-dimensional model of a possible wearer;
(d) graphically represent the first sides connected together so as to represent a garment piece assembly; and
(e) after a fit condition is met, graphically simulate the garment piece assembly being wrapped around a portion of the model and then connected together at the second sides.

14. The data storage device of claim 13, which includes at least one computer-readable instruction executable to:
(a) access at least one model data point of the model;
(b) access at least one garment data point of the garment piece assembly; and
(c) operatively couple the garment data point to the model data point.

15. The data storage device of claim 14, which includes at least one computer-readable instruction executable to mathematically couple the garment data point to the model data point.

16. The data storage device of claim 15, which includes at least one computer-readable instruction executable to graphically couple the garment data point to the model data point.

17. The data storage device of claim 13, which includes: (a) a plurality of model data points which specify the model; and (b) at least one computer-readable instruction executable to perform the simulation with accessing less than all of the model data points of the model.

18. The data storage device of claim 13, which includes at least one computer-readable instruction executable to represent a spatial relationship between the garment piece assembly and the model when the garment piece assembly is simulated as worn on the model.

19. The data storage device of claim 13, which includes at least one computer-readable instruction executable to automatically change at least one of the first and second pattern pieces in response to a change in an element selected from the group consisting of the model, the first garment piece, the second garment piece, and the garment piece assembly.

20. The data storage device of claim 13, which includes at least one computer-readable instruction executable to automatically change a representation of the garment piece assembly worn on the model in response to a change in the first pattern piece or a change in the second pattern piece.

21. A method comprising:
(a) graphically representing at least a first pattern piece and a second pattern piece;
(b) graphically representing: (i) at least a first garment piece corresponding to the first pattern piece, and (ii) at least a second garment piece corresponding to the second pattern piece, wherein the first and second garment pieces each have a plurality of sides including a first side and a second side;
(c) graphically representing a three-dimensional model of a possible wearer;
(d) graphically representing the first sides being connected together so as to represent a garment piece assembly; and
(e) after a fit condition is met, graphically simulating the garment piece assembly being wrapped around a portion of the model and then connected together at the second sides.

22. The method of claim 21, which includes:
(a) accessing at least one model data point of the model;
(b) accessing at least one garment data point of the garment piece assembly; and
(c) operatively coupling the garment data point to the model data point.

23. The method of claim 22, which includes mathematically coupling the garment data point to the model data point.

24. The method of claim 22, which includes graphically coupling the garment data point to the model data point.

25. The method of claim 21, which includes: (a) specifying the model with a plurality of model data points; and (b) accessing less than all of the model data points of the model.

26. The method of claim 21, which includes representing a spatial relationship between the garment piece assembly and the model when the garment piece assembly is simulated as worn on the model.

27. The method of claim 21, which includes automatically changing at least one of the first and second pattern pieces in response to a change in an element selected from the group consisting of the model, the first garment piece, the second garment piece, and the garment piece assembly.

28. The method of claim 21, which includes automatically changing a representation of the garment piece assembly worn on the model in response to a change in the first pattern piece or a change in the second pattern piece.
